(19) United States
(12) Patent Application Publication
(10) Pub. No.: US 2004/0173272 A1
(43) Pub. Date: Sep. 9, 2004

(54) Reinforcing element of underground pipe, and trenchless repairing and reinforcing method using the same

(75) Inventors: Ae Kwon Yoo, Youngin-si (KR); Woo Seok Chin, Taejon (KR); Jae Wook Kwon, Seoul (KR); Dai Gil Lee, Taejon (KR)

Correspondence Address: GRAYBEAL, JACKSON, HALEY LLP, 155 - 108TH AVENUE NE, SUITE 350, BELLEVUE, WA, 98004-5901, US

(73) Assignees: Korea Advanced Institute of Science and Technology (KR); Ae Kwon YOO

(21) Appl. No.: 10/774,753

(22) Filed: Feb. 9, 2004

Related U.S. Application Data
(63) Continuation of application No. PCT/KR01/01995, filed on Nov. 21, 2001.

(30) Foreign Application Priority Data
Aug. 8, 2001 (KR) 2001-47684

(51) Int. Cl. F16L 55/16

(52) U.S. Cl. 138/98; 138/104; 138/125; 405/184.2

(57) ABSTRACT

The present invention relates to a method for repairing and reinforcing an underground pipe. The method of the present invention comprises the steps of inserting an inner mold made of flexible material through the interior of a reinforcing element including a fiber preform surrounded by impermeable inner and outer tubes made of the flexible material and combining the inner mold with the reinforcing element; positioning a combined element, which includes the reinforcing element and the inner mold, into the underground pipe to be repaired and reinforced; injecting and expanding the inner mold with and by high temperature fluid, and brining the reinforcing element into close contact with an inner wall of the underground pipe; injecting the reinforcing element with thermosetting resin; and removing the inner mold after the thermosetting resin has been cured. According to the method of the present invention, there are advantages in that simplification of the processes and reduction of incidental expenses can be obtained since it is not necessary to fasten the cover for injecting the resin and air.

### PRIORTY CLAIM

This application is a continuation of the PCT Application No. PCT/KR01/01995, filed 21 Nov. 2001, which is herein incorporated by reference, that claims priority from Korean Patent Application No. 2001/47684 filed 8 Aug. 2001 herein incorporated by reference. This application claims the benefit of the filing date of the PCT Application under 35 USC §120; and claims priority from the Korean Patent Application.

### BACKGROUND OF THE INVENTION

1. Field of the Invention

The present invention relates to a reinforcing element, and more particularly, to a reinforcing element for reinforcing an inner wall of an underground pipe in a trenchless manner. The present invention is also directed to a method for repairing and reinforcing an underground pipe in a trenchless manner using fiber reinforced composite materials.

2. Description of the Prior Art

About 40% to 50% of underground pipes in the country have been subjected to strength degradation, cracking, breakage and corrosion due to a long-term use and poor maintenance. In case of a sewer pipe, since various kinds of waste water have flowed into the ground through damaged parts thereof, they causes pollution of soil and underground water and causes ground subsidence. Further, rainwater introduced into the underground pipe through the damaged parts creates many problems such as increase of the cost of sewage treatment. In case of a gas pipe, an explosion accident is likely to occur when gas leaks through damaged parts of the gas pipe, which may lead to great life damages. In addition, in case of a communication conduit, when underground water and the like permeate into the conduit through damaged parts thereof, high-priced communication cables may be damaged and communication interruption may occur. Thus, it results in loss of social overhead capital.

Further, since most of the underground pipes already constructed in the country have been used for a long time and have been designed and constructed without considering mechanical relationship between a buried depth thereof (a depth that the underground pipes are buried) and an overhead load thereof (a load that is applied by earth volume and vehicles above the underground pipes), and the maintenance thereof has been poor, they are generally degraded prior to designed life span thereof. As described in the foregoing, these damaged underground pipes have many problems such as environment pollution resulting from the waste water leakage, increase of the cost for sewage treatment, explosive hazard resulting from gas leakage, and loss of the social overhead capital resulting from the communication cable damages.

Nevertheless, in a case where these problems occurred, in order to repair or replace old underground pipes with new ones, a restriction of the traffic for a considerable time on a road under which the troubled underground pipes have been installed was made and the road was excavated by using a large number of workers and heavy construction equipment. However, since the above measures require a large quantity of expenses and time involved with expense of digging unimpaired roads, loss of the social overhead capital resulting from the traffic control for a long time, expense of repaving the roads and the like, a new trenchless rehabilitation method for shortening the period of construction and reducing the expenses is being nowadays developed to overcome the disadvantages of traditional excavation techniques.

Trenchless repairing methods that have been developed until now include a slip lining, a cured-in-place lining (CIPL), a close-fit lining and a spirally wound pipes lining and the like as examples of such developments. The most representative ones among these methods are a method of inserting an “inside-out” tube made of polyester resin impregnated nonwoven fabric and a spirally wound pipes lining using thermoplastic resin.

However, according to the former method, since the tube should be stored in a frozen state to prevent the polyester resin impregnated into the nonwoven fabric from being cured prior to the construction, a refrigerator vehicle is always used. Further, since the construction should be immediately performed just after the nonwoven fabric has been inserted into the tube, there are shortcomings in that it is very troublesome and requires a great deal of construction expense. Alternatively, according to the spirally wound pipes lining using the thermoplastic resin, there are shortcomings in that a large heater for melting down the thermoplastic resin is needed and an additional power supply (i.e., a motor) for transferring the highly viscous resin is also required.

Korean Patent No. 217696 discloses a technique related to “a liner for repairing degraded pipe and the coating method of the liner.”

Referring to FIG. 1, the technical features of the invention disclosed in the patent are briefly described as follows. The invention according to this prior art is directed to a protective layer by which wrinkles can be prevented from occurring onto an inner surface of a liner 1 owing to variation of the thermal expansion coefficients of a glass-fiber layer 2 and an inner foil 3 and the liner can be prevented from being broken, when high temperature and pressure vapor is produced in the liner 1 upon coating of a degraded sewer pipe with the liner 1. That is, the liner 1, in which the glass-fiber layer 2 impregnated with unsaturated polyester resin is formed between the pressure resistant inner and outer foils 3, 4 and the removable protective layer 5 for protecting the inner foil from being damaged is formed on an inner surface of the inner foil 3, is used in this patent.

Further, a method for coating the degraded sewer pipe with the liner 1 formed as such according to the invention of the patent comprises the steps of inserting the liner 1 into the degraded sewer pipe, expanding the liner 1 to bring the liner into close contact with an inner wall of the degraded sewer pipe, curing unsaturated resin by supplying the vapor into the expanded liner 1, cooling down the liner 1 by supplying compressed air, and removing the inner foil 3 and the protective layer 5 for protecting the inner foil from being damaged, which are inserted at an inner side of the liner 1.

However, there is a shortcoming in that a working process of the above patent is complex since the cured liner should be cooled down by an additional cooling device.

Korean Patent Application No. 2000-15776, which was filed by the applicant of the present application, discloses a technique related to a method for repairing and reinforcing a sewer pipe using resin transfer molding. Further, Korean Patent Application No. 2000-42253, which was filed by the present applicant, discloses a technique related to a method for repairing and reinforcing a sewer pipe using resin transfer molding with protective films.

According to these two patent applications, a cover for injecting resin and air into a sewer pipe should be fastened to an end of a reinforcing element after the reinforcing element has been positioned onto a reinforcing location of the sewer pipe. That is, there are many problems in performing the repairing and reinforcing works in that the workers themselves should fasten the cover within a narrow and dirty underground pipe.

Further, a method for repairing and reinforcing a sewer pipe using resin transfer molding according to Korean Patent Application No. 2000-15776 has a disadvantage in that underground water or waste water remaining within a sewer pipe permeates into a nonwoven or woven fabric, and thus, the nonwoven or woven fabric is prevented from being impregnated with resin, i.e. the wettability of the fabric is decreased. Therefore, there is a shortcoming in that the fabric quality is lowered and a desired reinforcing strength cannot be obtained.

### SUMMARY OF THE INVENTION

Therefore, the present invention is conceived to solve the aforementioned problems in the prior art. An object of the present invention is to provide a reinforcing element for easily reinforcing an inner wall of an underground pipe in a trenchless manner.

Another object of the present invention is to provide a method for easily repairing and reinforcing an underground pipe in a trenchless manner using thermosetting resin.

According to an aspect of the present invention for achieving the object, there is provided a reinforcing element for use in an underground pipe, comprising a tube body including impermeable inner and outer tubes made of flexible material and a fiber preform inserted between the tubes; a resin injecting tube formed at a lower portion in one of both ends of the tube body in which the inner and outer tubes are hermetically bonded to each other; an air discharge tube formed at an upper portion in the other end of the tube body; and a porous breathing tube inserted into the air discharge tube.

According to another aspect of the present invention, there is provided a method for repairing and reinforcing an underground pipe, comprising the steps of inserting an inner mold made of flexible material through the interior of a reinforcing element including a fiber preform surrounded by impermeable inner and outer tubes made of the flexible material and combining the inner mold with the reinforcing element; positioning a combined element, which includes the reinforcing element and the inner mold, into the underground pipe to be repaired and reinforced; injecting and expanding the inner mold with and by high temperature fluid, and brining the reinforcing element into close contact with an inner wall of the underground pipe; injecting the reinforcing element with thermosetting resin; and removing the inner mold after the thermosetting resin has been cured.

### BRIEF DESCRIPTION OF THE DRAWINGS

The above object and feature of the present invention will become apparent from the following description of preferred embodiments given in connection with the accompanying drawings, in which:

FIG. 1 is a schematic view showing structural components of a conventional liner used for repairing a degraded pipe in the prior art;

FIGS. 2 and 3 are an exploded perspective view and a sectional view showing structural components of a reinforcing element of an underground pipe according to the present invention, respectively;

FIG. 4 is a sectional view showing the other structural components of the reinforcing element of the underground pipe according to the present invention;

FIGS. 5 and 6 are an exploded perspective view and a sectional view showing the state where an inner mold is inserted into the reinforcing element of the underground pipe according to the present invention, respectively;

FIG. 7 is a schematic view illustrating a process of installing a rope in the underground pipe;

FIG. 8 is a schematic view illustrating a process of putting into the underground pipe a combined element in which a reinforcing element and an inner mold of the present invention are combined with each other;

FIG. 9 is a schematic view illustrating a process of supplying high temperature fluid to the inner mold shown in FIG. 8; and

FIG. 10 is a schematic view illustrating a process of impregnating thermosetting resin into a fiber preform shown in FIG. 8.

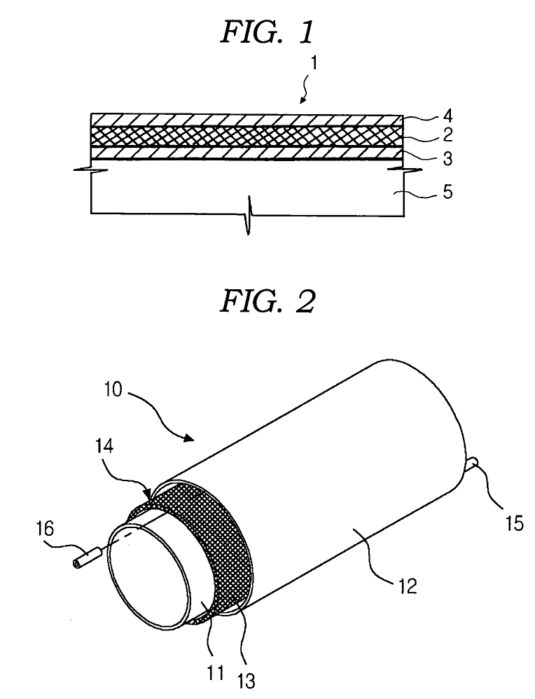

### DETAILED DESCRIPTION OF THE INVENTION

Hereinafter, a reinforcing element and a trenchless repairing and reinforcing method using the reinforcing element according to preferred embodiments of the present invention will be described in detail with reference to the accompanying drawings.

First, a reinforcing element of the present invention will be explained.

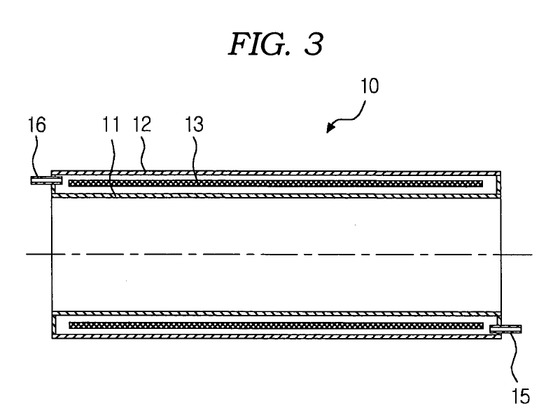

FIGS. 2 and 3 are an exploded perspective view and a sectional view showing structural components of the reinforcing element of an underground pipe according to the present invention, respectively. As shown in FIGS. 2 and 3, the reinforcing element 10 of the present invention comprises a tube body 14 including impermeable inner and outer tubes 11, 12 made of flexible material such as a PVC tube and a fiber preform 13 inserted between the tubes 11, 12; a resin inlet tube 15 formed at a lower portion in one of both ends of the tube body 14 in which the inner and outer tubes 11, 12 are hermetically bonded to each other; and an air vent tube 16 formed at an upper portion in the other end of the tube body 14.

The tube body 14 of the reinforcing element 10 is mass-produced and wrapped around a roll for storage thereof. The tube body is used by cutting it at a desired length thereof in a construction site upon reinforcement of the underground pipe. That is, the reinforcing element 10 of the present invention is manufactured in such a manner that the inner and outer tubes 11, 12 are hermetically bonded to each other after the resin inlet tube 15 for injecting the resin and the air vent tube 16 for discharging the air have been inserted into both ends of the cut tube body 14, respectively.

At this time, a fusion bonding method using a high frequency machining apparatus, an adhesive bonding method using an adhesive and a bonding method using a rubber sealant may be used for hermetically bonding the inner and outer tubes 11, 12 to each other.

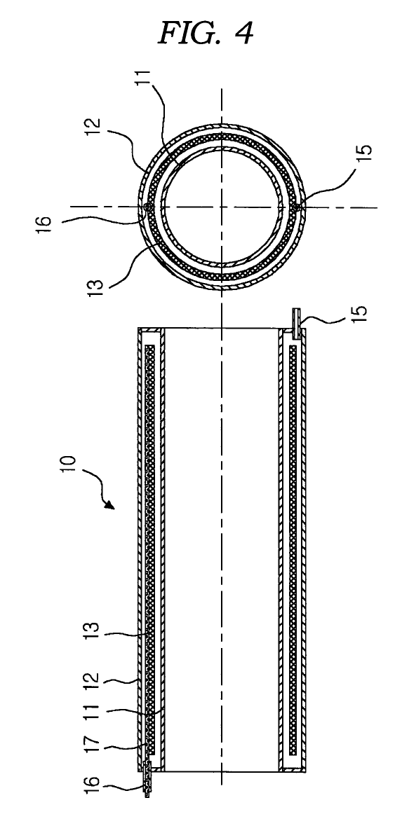

FIG. 4 is a sectional view showing the other structural components of the reinforcing element of the underground pipe according to the present invention. As shown in FIG. 4, the reinforcing element 10 further comprises a porous breathing tube 17 inserted into the air vent tube 16.

The porous breathing tube 17 is a thin tube made of flexible material, which is inserted into the air vent tube 16 in order to completely remove air bubbles from the fiber preform 13 and has a diameter smaller than that of the air vent tube 16. In such a case, since an outer portion of the breathing tube 17 is formed with a plurality of small holes, through which the air bubbles remaining in the preform 13 are, in turn, moved and removed.

As shown in FIGS. 3 and 4, the outer tube 12 of the reinforcing element 10 of the present invention not only prevents the fiber preform 13 from being scratched and damaged by an inner wall of the underground pipe but also has a function of a protective film for avoiding bad influence on resin impregnation by preventing the fiber prefrom from being wetted by underground water, waste water or the like remaining within the underground pipe. Further, it is preferred that the outer tube 12 be coated with an adhesive for increasing the bonding strength between the inner wall of the underground pipe and the outer tube and performing a function of a lubricant that can reduce friction therebetween when the reinforcing element is inserted into the underground pipe.

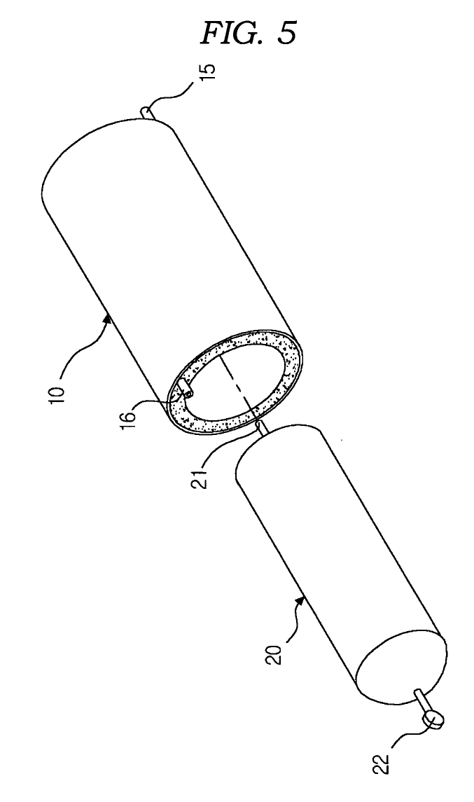

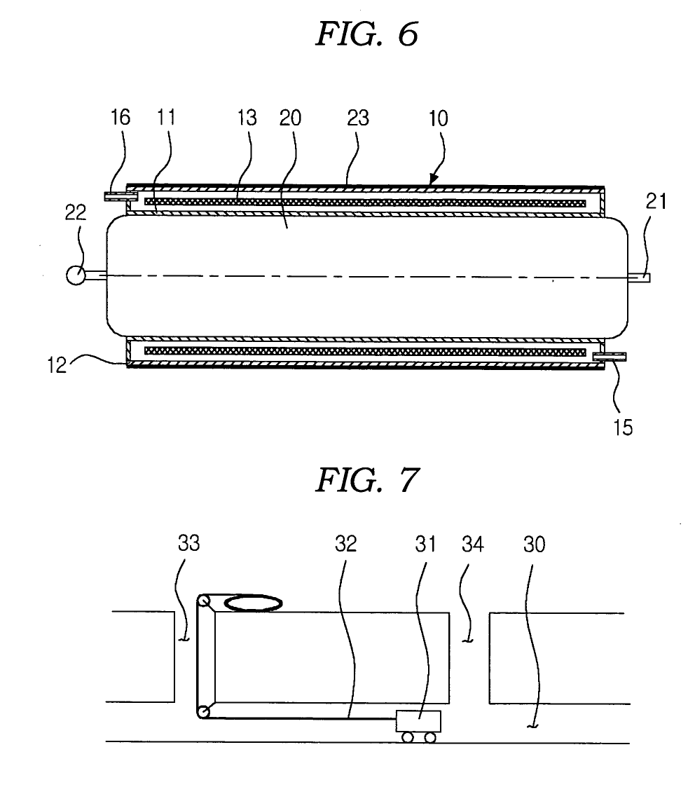

FIGS. 5 and 6 are an exploded perspective view and a sectional view showing the state where an inner mold is inserted into the reinforcing element of the underground pipe according to the present invention, respectively. As shown in FIGS. 5 and 6, an inner mold 20 made of flexible material is inserted into the interior of the reinforcing element 10 of the present invention. The inner mold 20 is configured to take the shape of an elongated tube that is sealed as a whole. Opposite ends of the inner mold 20 are formed with holes for air injection and pressure gauge installation, respectively. That is, an air inlet tube 21 is mounted to one end of the inner mold 20, while a pressure gauge 22 for indicating pressure within the inner mold 20 is mounted to the other end thereof.

Further, as described above, the inner mold 20 in which the air inlet tube 21 and the pressure gauge 22 are mounted to opposite ends thereof, respectively, may be inserted into the reinforcing element 10 constructed to include the porous breathing tube 17 shown in FIG. 4.

As shown in FIG. 6, the outer tube 12 of the reinforcing element 10 of the present invention is coated with an adhesive 23 for increasing the bonding strength between the inner wall of the underground pipe and the outer tube and performing a function of a lubricant that can reduce friction therebetween when the reinforcing element is inserted into the underground pipe.

Next, a method for repairing and reinforcing the underground pipe according to the present invention will be explained in detail.

An apparatus for performing the repairing and reinforcing method according to the present invention comprises the inner mold 20 made of flexible material and inserted into the reinforcing element 10 to keep a predetermined shape of the reinforcing element 10, a compressor or pump 25 mounted with a heater for injecting high temperature fluid (i.e., air or liquid) into the inner mold 20, and a resin supply device 26 for supplying resin to the inner mold. The method for repairing and reinforcing the inner wall of the underground pipe using the apparatus constructed as such is performed through the following three processes.

<First Process>

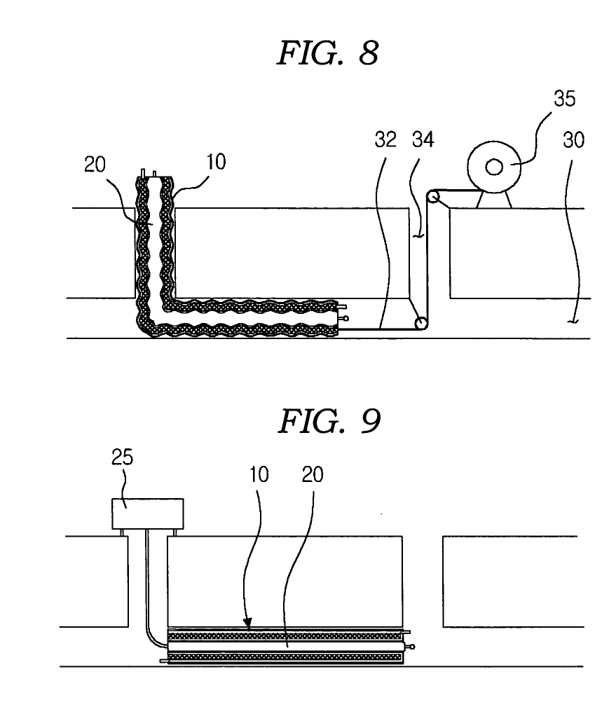

FIG. 7 is a schematic view illustrating a process of installing a rope in the underground pipe, and FIG. 8 is a schematic view illustrating a process of putting into the underground pipe a combined element in which the reinforcing element and the inner mold of the present invention are combined with each other.

First, the interior of the underground pipe 30 to be repaired and reinforced is cleaned by means of a robot 31 that can be moved along the underground pipe 30. Then, as shown in FIG. 7, the rope 32 is positioned into the underground pipe 30 between two adjacent manholes in such a manner that the robot 31 with the rope 32 fastened thereto is put into an arbitrary manhole 33, is caused to move along the underground pipe 30, and is retrieved through the next manhole 34.

Further, as shown in FIG. 8, the combined element in which the reinforcing element 10 constructed as shown in FIG. 6 is combined with the inner mold 20 made of the flexible material and inserted through the interior of the reinforcing element 10 is connected to an end of the rope 32. Then, the reinforcing element 10 and the inner mold 20 are caused to be positioned within the relevant underground pipe 30 by pulling the rope using a winding machine 35 from an opposite side of the rope.

<Second Process>

FIG. 9 is a schematic view illustrating a process of supplying high temperature fluid to the inner mold shown in FIG. 8. As shown in FIG. 9, the air inlet tube 21 that is positioned at the end of the inner mold 20 made of the flexible material is connected to the compressor or pump 25 mounted with the heater, and then causes the inner mold to be expanded by injecting the high temperature fluid (i.e., air or liquid) into the inner mold. Due to the injection of the high temperature fluid, an external appearance of the reinforcing element is kept as a tubular shape by melting down, cooling down and then curing binder within the fiber preform 13, and the reinforcing element 10 comes into close contact with the inner wall of the underground pipe. That is, due to heat of the injected fluid, the outer tube 12 of the reinforcing element 10 surrounding the fiber preform 13 is expanded toward and comes into close contact with the inner wall of the underground pipe 30. Then, the reinforcing element 10 is fixed to the inner wall of the underground pipe 30 by means of the adhesive 23 applied onto the outer tube 12.

The binder may not be added to the fiber preform 13 employed in the present invention, in a case where the fiber preform 13 can closely adhere to the underground pipe while maintaining its outer appearance and the fiber preform is made so strongly that its outer appearance cannot be deformed although it is thrust by the resin.

<Third Process>

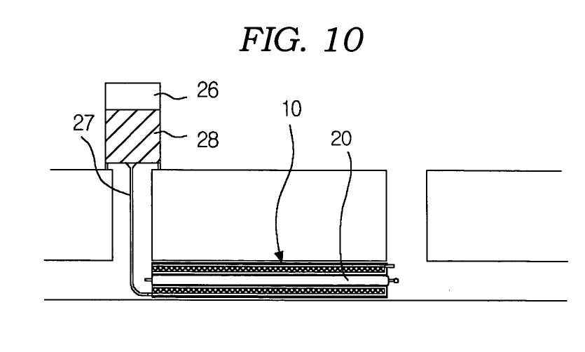

FIG. 10 is a schematic view illustrating a process of impregnating thermosetting resin into the fiber preform shown in FIG. 8. As shown in FIG. 10, the resin inlet tube 15 of the reinforcing element 10 is connected to one side of a supply tube 27. And, the resin supply device 26 is connected to the other side of the supply tube 27 and is supplied with the thermosetting resin 28. At this time, the resin to be used has low viscosity since it is comprised of a monomer. Thus, since the resin can be easily transported, relatively low power is consumed during injection of the resin. When the thermosetting resin 28 is impregnated into the fiber preform 13 and is gradually filled between the inner and outer tubes 11, 12, the air residing between the inner and outer tubes 11, 12 is caused to be discharged through the air vent tube 16 to the outside. After the resin has been injected and then cured completely, the inner mold 20 is removed from the underground pipe. Thus, the inner wall of the underground pipe 30 has been repaired and reinforced with the reinforcing element 10 of the present invention are completed.

The outer tube 12 of the reinforcing element 10 used for the repair and reinforcement of the underground pipe serves as the protective film for avoiding bad influence on the resin impregnation by preventing the fiber prefrom 13 from being wetted by the underground water, waste water and the like remaining within the underground pipe, while the inner tube 11 thereof serves as a coating film.

Further, the tube body 14 of the reinforcing element 10 is mass-produced and wrapped around the roll for storage thereof, and is also used by cutting it at a desired length thereof in a construction site upon reinforcement of the underground pipe.

Furthermore, in a case where the underground pipe is repaired and reinforced by means of the reinforcing element 10 of the present invention, the air bubbles remaining between the inner and outer tubes 11, 12 can be more completely removed through the porous breathing tube 17 upon injection of the resin.

At this time, in a case where the underground pipe to be repaired is a gravity pipe, the porous breathing tube 17 may not be removed since great strength of the reinforced pipe is not required. However, in a case where the underground pipe is a pressure pipe, the strength of the reinforced pipe is significant. Thus, the porous breathing tube 17 should be removed after the resin injecting process since it can be a weak part when the underground pipe is subjected to a load. In such a case, since a portion of the porous breathing tube 17 protrudes beyond the air vent tube 16 toward the outside, the porous breathing tube can be removed by pulling the protruded portion thereof.

If desired, in order to completely remove the air between the inner and outer tubes 11, 12, a vacuum may be applied, during the third process, to the air vent tube 16 through which the air is discharged.

In addition, by repeating the second process once again after the resin injection has been completed, the inner mold 20 made of the flexible material can be injected with and expanded by the air. Thus, the effects of squeezing the resin within the mold can be obtained. Consequently, the fiber volume fraction of the reinforced pipe can be further increased and the air bubbles can also be further removed.

As described in detail in the foregoing, according to the method for repairing and reinforcing the underground pipe according to the present invention, simplification of the processes and reduction of incidental expenses can be obtained since it is not necessary to fasten the cover for injecting the resin and air.

Further, according to the method for repairing and reinforcing the underground pipe according to the present invention, repairing and reinforcing effects are excellent since the outer tube serves as the protective film while the inner tube serves as the coating film.

Furthermore, the method for repairing and reinforcing the underground pipe according to the present invention can be employed for repairing and reinforcing a water supply pipe by selecting and using a resin that is harmless to humans. Moreover, the present invention can be employed for repairing and reinforcing a gas pipe, a communication conduit or the like.

Although the reinforcing element of the underground pipe and the trenchless repairing and reinforcing method using the reinforcing element according to the present invention have been described above with reference to the accompanying drawings, they illustrate the most preferred embodiment of the present invention only by way of example. Therefore, the present invention is not limited thereto.

While the invention has been shown and described with respect to the preferred embodiment, it will be understood by a person skilled in the art that various changes and modifications may be made without departing from the spirit and scope of the invention as defined in the following claims.

What is claimed is:

1. A reinforcing element for use in an underground pipe, comprising:
a tube body including impermeable inner and outer tubes made of flexible material and a fiber preform inserted between the tubes, and having two ends where the inner and outer tubes are hermetically bonded to each other;
a resin inlet tube formed at a lower portion in one end of the tube body;
an air vent tube formed at an upper portion in the other end of the tube body; and
a porous breathing tube inserted into the air discharge tube.

2. A method for repairing and reinforcing an underground pipe, comprising the steps of:
inserting an inner mold made of flexible material through the interior of a reinforcing element including a fiber preform surrounded by impermeable inner and outer tubes made of the flexible material and combining the inner mold with the reinforcing element;
positioning a combined element, which includes the reinforcing element and the inner mold, into the underground pipe to be repaired and reinforced;
injecting and expanding the inner mold with and by high temperature fluid, and brining the reinforcing element into close contact with an inner wall of the underground pipe;
injecting the reinforcing element with thermosetting resin; and
removing the inner mold after the thermosetting resin has been cured.

3. The method as claimed in claim 2, wherein the step of injecting and expanding the inner mold with and by the high temperature fluid is repeated once more after the step of injecting the reinforcing element with the resin.

4. The method as claimed in claim 2, wherein the step of injecting the reinforcing element with the thermosetting resin comprises the steps of injecting the thermosetting resin through an end of the reinforcing element and discharging air from the other end thereof into which a porous breathing tube for facilitating removing air bubbles is inserted.

5. The method as claimed in claim 2, wherein the step of positioning the combined element into the underground pipe comprises the step of applying an adhesive to the outer tube of the reinforcing element.

6. The method as claimed in claim 4, wherein the breathing tube is removed after the thermosetting resin has been injected, in a case where the underground pipe is a pressure pipe.

7. The method as claimed in claim 2, wherein the reinforcing element is stored in the form of a roll before the step of combining the inner mold therewith.

8. The method as claimed in claim 4, wherein a vacuum is applied to the other end of the reinforcing element during the step of injecting the reinforcing element with the thermosetting resin.
